(19) United States
(12) Patent Application Publication
(10) Pub. No.: US 2026/0360202 A1
(43) Pub. Date: Nov. 12, 2026

(54) FOREIGN OBJECT DETECTION FOR MEDIA TERMINALS

(71) Applicant: Cardtronics USA, Inc., Atlanta, GA (US)

(72) Inventor: Scott Low Colston, Dundee (GB)

(21) Appl. No.: 19/202,409

(22) Filed: May 8, 2025

(51) Int. Cl. G07D 11/237

(52) U.S. Cl. CPC G07D 11/237

(57) ABSTRACT

A system and method for handling foreign objects in a media depository includes foreign object detection sensors positioned after a pocket separator along a media transport path. The sensors detect metal and measure thickness of individual separated notes. Upon detecting a foreign object, the system employs a reversible transport path to stop and redirect the note containing the foreign object through a divert gate into a dedicated storage area. This automated diversion prevents system downtime by allowing continued operation until service personnel can conveniently remove accumulated foreign objects from the storage area.

### BACKGROUND

Media depositories in self-service terminals (SSTs) face significant challenges with foreign object detection, particularly during bulk note deposits. Current detection systems typically attempt to identify foreign objects while notes are still bundled together at the input area, making it difficult to accurately detect small items like staples, especially when notes contain metallic security features. The detection challenge is further complicated by the metal enclosure and moving parts of the systems themselves. While detection becomes easier after note separation, by the time foreign objects are identified they have already entered the device, requiring manual intervention by service personnel to remove them and restore operation.

### BRIEF DESCRIPTION OF THE DRAWINGS

FIG. 1 is a diagram of a depository/recycler with a foreign object detection apparatus, according to an example embodiment.

FIG. 2 is diagram of a pocket separator and bill validator interfaced to a foreign object detection apparatus, according to an example embodiment.

FIG. 3 is diagram of a foreign object detection apparatus, according to an example embodiment.

FIG. 4 is a diagram of a system that includes a foreign object detection apparatus, according to an example embodiment.

FIG. 5 is a diagram of a flow diagram of a method of operating a foreign object detection apparatus, according to an example embodiment.

### DETAILED DESCRIPTION

Media depositories in automated self-service terminals (SSTs) encounter operational disruptions when foreign objects enter the system during bulk note deposits. When users deposit bunches of notes containing items like staples, paper clips, or other debris, these objects often go undetected until they have already entered deep into the machine's internal mechanisms. Traditional detection methods struggle particularly with small metallic objects that are masked by the legitimate metallic security features present in many banknotes. The presence of metal components within the machine housing and transport mechanisms further complicates reliable foreign object detection. Once foreign objects penetrate beyond the input area, they frequently cause mechanical failures requiring service technician intervention, resulting in extended machine downtime and potential damage to internal components.

In an embodiment, foreign object detection sensors are strategically positioned along the media transport path immediately following the pocket separator module. This positioning enables the sensors to examine individual notes after separation from the deposited bunch, significantly improving detection accuracy for both metallic and non-metallic foreign objects.

The technology disclosed herein incorporates both metal detection and thickness measurement capabilities within a single detection subsystem positioned after note separation along the media transport path. Upon detecting a foreign object, the transport path automatically halts. A reversible transport mechanism, working in conjunction with a divert gate, redirects the note containing the foreign object to a dedicated storage area.

In various embodiments presented, the dedicated storage area serves as a temporary containment zone for notes containing foreign objects, allowing the media terminal to remain operational until service personnel can conveniently access and clear the storage area. This configuration prevents immediate system shutdown and eliminates the need for emergency service calls, thereby maintaining higher system availability while reducing maintenance costs and potential internal component damage.

The technology provides significant operational benefits by preventing foreign objects from reaching critical internal mechanisms of the media terminal. This preventive approach reduces maintenance costs, increases machine uptime, and protects valuable internal components from damage. The strategic positioning of the foreign object detection apparatus immediately after the pocket separator enables precise detection while still allowing for automated diversion of problematic items before they can cause damage.

As used herein, a ‘media terminal’ includes a self-service terminal (SST). The SST may include an automated teller machine (ATM), a self-checkout (SCO) terminal that handles cash, or a kiosk that handles cash. The terms and phrases ‘cash,’ ‘media item,’ ‘media note,’ ‘bank note,’ ‘check,’ ‘bill,’ and ‘currency item’ may be used interchangeably and synonymously herein to refer to valuable media items being deposited by a user during a transaction. Furthermore, the terms ‘user,’ ‘customer,’ or ‘consumer’ may be used interchangeably and synonymously herein to refer to an individual depositing a bunch of valuable media items during a media transaction at the media terminal. The bunch of media items can include a same type of media or mixed types of media. For example, a user may deposit a bunch of media that includes a combination of cash and checks, deposit a bunch of checks, or deposit a bunch of cash. The bunch refers to multiple media items presented simultaneously for deposit at the media terminal.

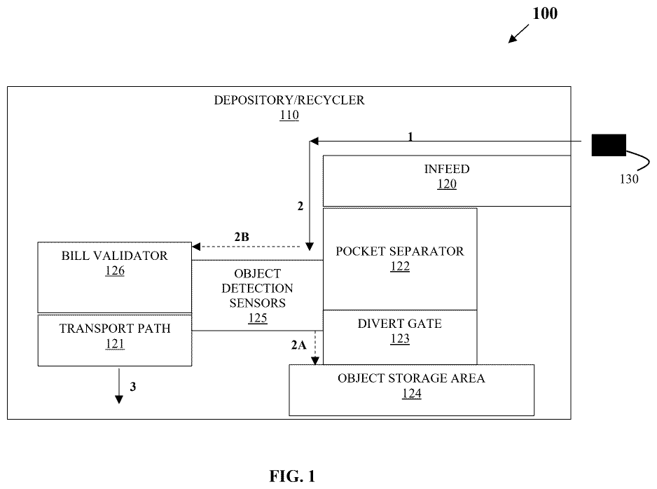

FIG. 1 is a diagram 100 of a depository/recycler with a foreign object detection apparatus, according to an example embodiment. Notably, the components are shown schematically in simplified form, with only those components relevant to understanding of the embodiments being illustrated.

Furthermore, the various components (that are identified in diagram 100) are illustrated and the arrangement of the components are presented for purposes of illustration only. Notably, other arrangements with more or less components are possible without departing from the teachings presented herein and below.

FIG. 1 illustrates a depository/recycler 110 with an infeed 120, a pocket separator 122, a bill validator 126, a transport path 121, and a foreign object detection apparatus, which includes object detection sensors 125, a divert gate 123, and a storage area 124. At 1, a bunch of media items 130 are inserted for deposit into infeed 120. At 2, the bunch of media items 130 are moved into pocket separator 122 where each media item is separated from the bunch of media items 130 and each media item is individually processed through the foreign object detection apparatus.

Object sensors 125 detect whether a processed media item includes metal through a metal sensor or whether a processed media item is thicker than a preconfigured thickness expected for media items. When the sensors report either a metal material or a thickness that exceeds a threshold, at 2A, divert gate 123 is activated causing the processed media item to be urged into the object storage area 124.

If object sensors 125 do not report a presence of metal or a thickness that exceeds a threshold for the processed media item, at 2B, the processed media item is urged into bill validator 126 where the media item is validated for genuineness, counterfeits, and fitness for circulation. Once the bill validator 126 reports its findings for the processed media item, the processed media item, at 3, is urged onto a media transport path 121 for further downstream processing within the depository/recycler 110. The downstream processing can include rejecting the media item or accepting the media item for a transaction such as a cash deposit transaction or a payment transaction.

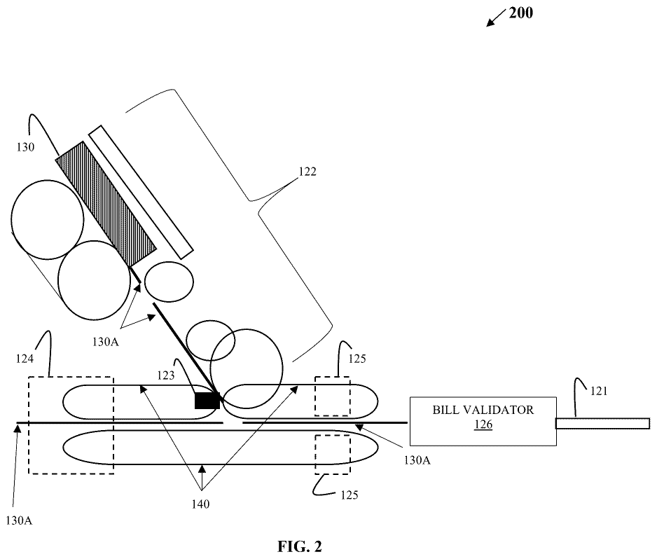

FIG. 2 is diagram 200 of a pocket separator and bill validator interfaced to a foreign object detection apparatus, according to an example embodiment. FIG. 2 illustrates how the foreign object detection apparatus is situated between and interfaced to the pocket separator 122 and the bill validator 126.

A bunch of media items are received within the pocket separator 122, the pocket separator 122 separates a leading edge of each media item 130A and each media item 130A is received within the foreign object detection apparatus. The foreign object detection apparatus includes at least three reversible transport belts 140, at least two foreign object detection sensors 125, a divert gate 123, and a storage area 124. The sensors 125 are situated on opposing sides of the path such that both sides of the media item 130A can be evaluated by each sensor 125. When metal is detected on the media item 130A and/or when the media item 130A exceeds a predefined or threshold thickness as reported by sensors 125, the reversible belts 140, move the media item away from the direction of the bill validator 126 back towards divert gate 123 where divert gate 123 is activated or opened permitting the reversible belts 140 to urge the media item 130A into storage area 124.

When the media item does not include any metal and does not exceed a predefined thickness, the reversible belts 140 continue to urge the media item 130A towards the direction of the bill validator 126. The bill validator 126 takes validation measurements, reports the measurements and urges the media item onto the transport path 121 for further downstream processing within the depository/recycler 110.

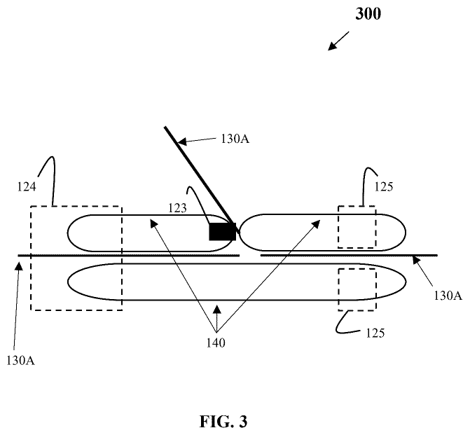

FIG. 3 is diagram of a foreign object detection apparatus 300, according to an example embodiment. The foreign object detection apparatus 300 includes foreign object detection sensors 125, a divert gate 123, a storage area 124, and reversible belts 140.

The foreign object detection apparatus 300 is configured to receive a media item 130A that exits pocket separator 122. Reversible belts 140 are configured to transport a media item 130A in a direction towards the bill validator 126 and reverse the transport direction back towards divert gate 123 and storage area 124 when sensors 125 report measurements or metrics that indicate the media item 130A includes a foreign metal object or is thicker than what is expected. A processor of the depository/recycler 110 executes firmware and the firmware evaluates the readings, measurements, and/or metrics reported by sensors 125 to determine whether to cause reversible belts 140 to urge a given media item into bill validator or urge the media item in a reverse direction back towards divert gate 123 and storage area 124.

In an embodiment, the storage area 124 includes a shutter accessible on an outside surface of a housing from the depository/recycler 110. This permits a user to retrieve any bank notes that have metal items affixed to them, such as a staple or a paperclip or have something else affixed to them causing their thickness to exceed a predefined thickness. The user may retrieve the rejected banknotes via the shutter and if possible, remove the foreign object attached and attempt to insert the notes again into the depository/recycler 110 for a transaction.

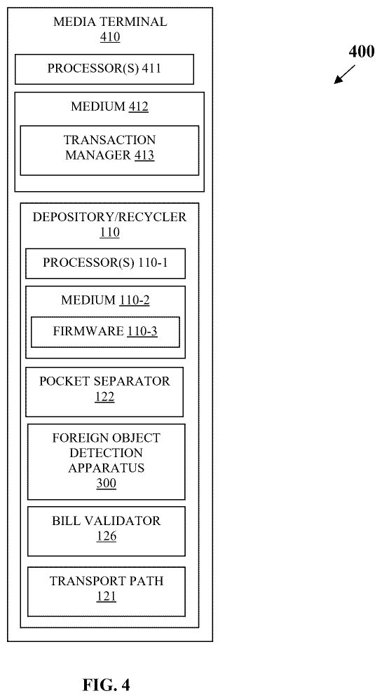

FIG. 4 is a diagram of a system 400 that includes a foreign object detection apparatus, according to an example embodiment. Notably, the components are shown schematically in simplified form, with only those components relevant to understanding of the embodiments being illustrated.

The system 400 includes a media terminal 410 and a depository/recycler 110. The media terminal 410 includes at least one processor 411 and a non-transitory computer-readable storage medium 412, which includes instructions for a transaction manager 413. The instructions when executed by the processor 411 cause the processor 411 to perform operations discussed herein with respect to transaction manager 413.

Depository/Recycler 110 includes at least one processor 110-1 and a medium 110-2, which include instructions for firmware 110-3. The instructions when executed by processor 110-1 cause processor 110-1 to perform operations discussed herein with respect to firmware 110-3. Depository/Recycler 110 further includes a pocket separator 122, the foreign object detection apparatus 300, a bill validator 126, and transport path 121.

Transaction manager 413 performs transactions at the media terminal 410 by interacting with a user through a transaction interface and interacting with depository/recycler 110. The transactions may include media deposits, media withdrawals, and/or payments for transactions using cash provided by the user.

In an embodiment, the media terminal 410 is an automated teller machine (ATM). In an embodiment media terminal 410 is a self-checkout (SCO) terminal. In an embodiment, media terminal 410 is a kiosk that accepts cash as forms of payment during transactions at the kiosk.

During a payment transaction or a media deposit transaction by a user at the media terminal 410, firmware detects a bunch of media items received at pocket separator 122. Each media item is separated from the bunch of media items and urged into the foreign object detection apparatus 300. The firmware 110-3 receives readings, measurements, and/or metrics reported by sensors 125 and based on results that indicate a presence of a foreign object, firmware 110-3 causes reversible belts 140 to reverse the direction of a processed media item from the direction towards bill validator 126 back towards divert gate 123 and storage area 124. Assuming firmware 110-3 receives no readings from sensors 125 indicating the presence of a foreign object, firmware 110-3 allows reversible belts 140 to continue to urge the media item into bill validator 126. Once bill validator 126 reports its measurements, readings, and/or metrics, the media item is urged onto transport path 121 where it continues for downstream processing within depository/recycler 110.

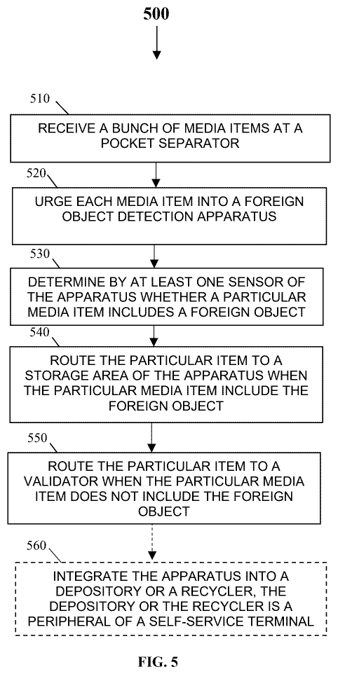

FIG. 5 is a diagram of a flow diagram of a method 500 of operating a foreign object detection apparatus, according to an example embodiment. The method 500 is executed by firmware of a processor for a depository/recycler 110. In an embodiment, the instructions executed by the processor 411 are firmware 110-3.

At 510, firmware 110-3 receives a bunch of media items at a pocket separator 122. At 520, the firmware 110-3 urges each media item into a foreign object detection apparatus 300.

At 530, firmware 110-3 determines, using at least one sensor 125 of the apparatus 300 whether a particular media item includes a foreign object. At 540, firmware 110-3 routes the particular media item to a storage area 124 of the apparatus 300 when the particular media item includes the foreign object.

At 550, firmware 110-3 routes the particular item to a validator 126 when the particular media item does not include the foreign object. In an embodiment, the apparatus 300 is integrated into a depository/recycler 110. The depository/recycler 110 is a peripheral of a media terminal 410.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A foreign object detection apparatus, comprising:
reversible transport belts configured to transport media items;
one or more object detection sensors positioned along the reversible transport belts wherein the one or more object detection sensors comprise a metal detection sensor configured to detect a presence of metal on a media item and a thickness sensor configured to detect when a media item exceeds a predefined thickness, the one or more object detection sensors positioned on opposing sides of a path defined by the reversible transport belts such that both sides of each media item are evaluated;
a divert gate; and
a storage area accessible from an outside surface of a housing and configured to temporarily store media items having foreign objects until service personnel clear the storage area;
wherein the divert gate is structurally separate from the reversible transport belts and is movable relative to the reversible transport belts between a closed position that permits transport of a media item in an initial direction toward a bill validator and an open position that provides access to the storage area;
wherein the one or more object detection sensors are configured to evaluate each media item transported by the reversible transport belts and when a foreign object is detected, the reversible transport belts stop, the divert gate moves from the closed position to the open position, and the reversible transport belts thereafter reverse an initial direction to transport a corresponding media item in an opposite direction back towards the divert gate and through the divert gate into the storage area, wherein the foreign object detection apparatus is positioned between and interfaced to a pocket separator on a first end and a bill validator on a second end such that each media item is individually evaluated after separation from a bunch of media items by the pocket separator before reaching the bill validator.

2. The foreign object detection apparatus of claim 1, wherein the one or more object detection sensors comprise two sensors positioned on opposing sides of a path defined by the reversible transport belts.

3. The foreign object detection apparatus of claim 2, wherein two sensors comprise a first metal detection sensor and a second media thickness sensor.

4. The foreign object detection apparatus of claim 3, wherein the first metal detection sensor is configured to detect a presence of metal on each item, and wherein the second media thickness sensor is configured to detect when each media item exceeds a predefined thickness.

5. The foreign object detection apparatus of claim 1, wherein the foreign object detection apparatus is configured to interface to a pocket separator on a first end and interface to a bill validator on a second end.

6. The foreign object detection apparatus of claim 5 wherein the pocket separator provides separated media items from a bunch of media items to the foreign object detection apparatus.

7. The foreign object detection apparatus of claim 5, wherein when no foreign object is detected the reversible transport belts continue to transport a particular media item to the bill validator.

8. The foreign object detection apparatus of claim 1, wherein the storage area includes a shutter accessible from an outside surface of a housing.

9. The foreign object detection apparatus of claim 1, wherein the foreign object detection apparatus is integrated into a depository.

10. The foreign object detection apparatus of claim 1, wherein the foreign object detection apparatus is integrated into a recycler.

11. The foreign object detection apparatus of claim 1, wherein the storage area temporarily stores media items having foreign objects until service personnel clear the storage area.

12. A system, comprising:
a media terminal interfaced to a depository or a recycler;
the depository or the recycler comprising at least one processor and a medium comprising firmware; and
a foreign object detection apparatus comprising:
reversible transport belts;
object detection sensors positioned along the reversible transport belts, wherein the object detection sensors include a metal detector sensor and a thickness sensor, wherein the object detection sensors are positioned on opposing sides of a path defined by the reversible transport belts such that both sides of each media item are evaluated;
a divert gate, and
a storage area accessible from an outside surface of a housing of the depository or the recycler and configured to temporarily store media items having foreign objects until service personnel clear the storage area;
wherein the divert gate is structurally separate from the reversible transport belts and is movable relative to the reversible transport belts between a closed position that permits transport of a media item in a forward direction toward a bill validator and an open position that provides access to the storage area;
wherein the firmware is configured to receive readings from the object detection sensors for each media item individually separated from a bunch of media items by a pocket separator positioned on a first end of the foreign object detection apparatus, evaluate the readings to determine whether a foreign object comprising metal or an object exceeding a predefined thickness is present on a media item;
wherein the firmware configured to evaluate readings from the object detection sensors for each media item transported by the reversible transport belts and when a foreign object is detected the firmware causes the reversible transport belts to stop, causes the divert gate to move from the closed position to the open position, and thereafter causes the reversible transport belts to reverse direction to transport a corresponding media item back towards through the divert gate and into the storage area.

13. The system of claim 12, wherein the media terminal is an automated teller machine, a self-service terminal, or a kiosk.

14. The system of claim 13, wherein media terminal is configured to process one or more of media deposit transactions or payment transactions through interaction with the depository or the recycler.

15. The system of claim 12, wherein the depository or the recycler further comprises a pocket separator and a bill validator, wherein the foreign object detection apparatus is situated between and interfaced to the pocket separator and the bill validator.

16. The system of claim 12, wherein the firmware is configured to cause routing of media items having no foreign objects detected to a bill validator and cause routing of other media items having foreign objects detected to the storage area.

17. The system of claim 12, wherein the depository or the recycler is an integrated peripheral of the media terminal.

18. The system of claim 12, wherein the depository or the recycler further comprises a transport path, wherein media items having no foreign objects detected are urged into a bill validator for media validation and then onto a transport path by the bill validator for downstream processing within the depository or the recycler.

19. A method, comprising:
receiving a bunch of media items at a pocket separator;
urging each media item individually into a foreign object detection apparatus positioned between the pocket separator and a bill validator; evaluating, using at least one metal detection sensor and at least one thickness sensor of the foreign object detection apparatus positioned on opposing sides of a path through the foreign object detection apparatus, both sides of each media item to determine whether a particular media item includes a foreign object;
when the particular media item includes the foreign object, stopping reversible transport belts, moving a divert gate that is structurally separate from the reversible transport belts relative to the reversible transport belts from a closed position to an open position that provides access to a storage area, and thereafter routing the particular media item to the storage area of the foreign object detection apparatus by reversing a direction of reversible transport belts to transport the particular media item back toward a divert gate and into the storage area when the particular media item includes the foreign object; and
routing the particular media item to a validator by continuing transport of the particular media item by the reversible transport belts in a forward direction toward the bill validator when the particular media item does not include the foreign object.

20. The method of claim 19, further comprising:
integrating the foreign object detection apparatus into a depository or a recycler, wherein the depository or the recycler is a peripheral of a media terminal.
